(19) United States
(12) Patent Application Publication
(10) Pub. No.: US 2026/0133983 A1
(43) Pub. Date: May 14, 2026

(54) CLOUD-BASED CRM DATA STORAGE SYSTEM WITH QUERY SUPPORT

(71) Applicant: DRUVA INC., Santa Clara, CA (US)

(72) Inventors: Prahlad NISHAL, Basai, Gurgaon, Haryana (IN); Abhijit Ashok VAIDYA, Pune, Maharashtra (IN)

(21) Appl. No.: 19/382,056

(22) Filed: Nov. 6, 2025

(30) Foreign Application Priority Data
Nov. 12, 2024 (IN) 202441086987

(51) Int. Cl. G06F 16/2458; G06F 11/14; G06F 16/22; G06F 16/23

(52) U.S. Cl. CPC G06F 16/2474; G06F 11/1464; G06F 16/221; G06F 16/2219; G06F 16/2379; G06F 2201/84

(57) ABSTRACT

A cloud-based (CRM) data storage system with query support is provided. The system includes a memory storing processor-executable routines and a processor configured to execute routines to initiate a data backup operation for customers of the system. The processor is configured to receive source data having at least one of data schema, records/CRM data, and blob data and to transform the source data into a columnar storage format to generate converted source data and corresponding index files. Further, versioning data for the source data, converted source data and corresponding index files for each customer are stored. The processor is configured to receive a data query having query parameters from customers and to identify index files and/or data files to be scanned from the converted source data, and to scan the identified index files and/or data files to generate data query results.

### PRIORITY STATEMENT

The present application claims priority under 35 U.S.C. § 119 to Indian Patent Application number 202441086987 filed 12 Nov. 2024 the entire contents of which are hereby incorporated herein by reference.

### FIELD OF INVENTION

Embodiments of the present disclosure generally relate to the field of data management systems, and specifically to techniques of data storage, and data retrieval with data query functionalities such as those implemented in customer relationship management (CRM) platforms.

### BACKGROUND

In modern data-driven enterprises, organisations rely on Software-as-a-Service (Saas) applications to generate, store, and manage large volumes of data. Representative examples of such applications include Customer Relationship Management (CRM) platforms like Salesforce and Microsoft Dynamics 365. These platforms typically maintain information in a tabular format comprising multiple tables that define relationships between parent and child entities. Data stored using such tables may be accessed using SQL-like query interfaces or developer (Application Programming Interface) APIs to enable third-party integrations and analytical operations.

Customers of such SaaS platforms often need to back up and retain their organisational data for compliance, regulatory, and analytical purposes. However, implementing an efficient and scalable backup mechanism for tabular data is challenging. Each customer organization may have a unique and dynamically evolving schema, making it complex to capture and maintain schema changes consistently across multiple versions or snapshots of data. Moreover, it is challenging to store and support multiple versions of data generated by the organisations while being scalable and cost-efficient.

Conventional row-based storage architectures are optimised for transactional workloads rather than analytical queries that typically access only a subset of data columns. Although relational database management systems (RDS) provide structured data organisation, the absence of native versioning and snapshot capabilities constrains efficient data backup, recovery, and point-in-time query operations.

Non-relational or NoSQL databases offer improved scalability and schema flexibility but may lack robust SQL-like query capabilities across large structured datasets. These systems also are not able to efficiently execute queries across multiple versions of related data. File-based or block-based storage systems, while simple to implement, do not provide schema awareness, efficient indexing, or relational integrity, making them unsuitable for large-scale, versioned tabular data storage.

Data-lake based solutions and open table formats, such as Apache Iceberg or Amazon Redshift-based lakehouses, support columnar storage but have limitations in managing multiple schema versions, executing point-in-time queries, and performing efficient joins across relational datasets. These solutions often require complex orchestration layers, leading to high compute costs and latency in query execution.

Accordingly, there exists a need for a scalable and cost-efficient storage framework capable of backing up tabular CRM data with query support and handling multiple versions of both data and schema.

### BRIEF DESCRIPTION

The following description is illustrative only and is not intended to be in any way limiting. In addition to the illustrative aspects, example embodiments, and features described, further aspects, example embodiments, and features will become apparent by reference to the drawings and the following detailed description.

Briefly, according to the example embodiments, a cloud-based customer relationship management (CRM) data storage system with query support is provided. The system includes a memory storing one or more processor-executable routines and a processor communicatively coupled to the memory. The processor is configured to execute one or more processor-executable routines to initiate a data backup operation for one or more customers of the cloud-based data storage system. The processor is further configured to receive source data corresponding to the one or more customers. The source data comprises at least one of data schema, records/CRM data, and blob data. The processor is further configured to transform the received source data into a columnar storage format to generate converted source data. The processor is further configured to generate index files for the converted source data. The processor is further configured to store versioning data for the source data using a database. The processor is further configured to store converted source data and corresponding index files for each customer using a blob storage. The processor is further configured to receive a data query from one or more customers. The data query comprises one or more query parameters. The processor is further configured to identify index files and/or data files to be scanned from the converted source data based on the one or more query parameters and the versioning data. The processor is further configured to scan the identified index files and/or data files to generate data query results.

According to another example embodiment, a cloud-based (CRM) data storage system with query support is provided. The system includes a memory storing one or more processor-executable routines and a processor communicatively coupled to the memory. The processor is configured to execute one or more processor-executable routines to facilitate data backup and data retrieval operations for customer data. The processor includes a client interface configured to receive source data corresponding to one or more customers. The source data comprises at least one of data schema, records/CRM data and blob data. The processor also includes a data transformation module configured to transform the received source data into a columnar storage format to generate converted source data and generate index files for the converted source data. The processor also includes a data query engine configured to receive a data query from the one or more customers. The data query comprises one or more query parameters. The data query engine is configured to identify index files and/or data files to be scanned from the converted source data based on the one or more query parameters and versioning data. The data query engine is further configured to scan the identified index files and/or data files to generate data query results.

According to another example embodiment, a method of providing query support in a cloud-based (CRM) data storage system is provided. The method includes initiating a data backup operation for one or more customers of the cloud-based data storage system. The method further receiving source data corresponding to the one or more customers. The source data comprises at least one of data schema, records/CRM data and blob data. The method further includes transforming the received source data into a columnar storage format to generate converted source data. The method further includes generating index files for the converted source data. The method further includes storing versioning data and corresponding index files for each customer. The method further includes receiving a data query from one or more customers. The data query having one or more query parameters. The method further includes identifying index files and/or data files to be scanned from the converted source data based on the one or more query parameters and the versioning data.

### BRIEF DESCRIPTION OF THE DRAWINGS

The disclosure will be described and explained with additional specificity and detail with the accompanying figures in which:

FIG. 1 is a block diagram illustrating components of a cloud-based customer relationship management (CRM) data storage system with query support, according to some aspects of the present description;

FIG. 2 is an example backup workflow of the cloud-based CRM data copy system 100 of FIG. 1;

FIG. 3 is an example query execution workflow of the cloud-based CRM data copy system 100 of FIG. 1;

FIG. 4 is a flowchart illustrating a method of providing query support in a cloud-based (CRM) data storage system of FIG. 1; and

FIG. 5 is a block diagram of an embodiment of a computing device in which a cloud-based customer relationship management (CRM) data storage system with query support, described herein, is implemented.

### DETAILED DESCRIPTION

Various example embodiments will now be described more fully with reference to the accompanying drawings in which only some example embodiments are shown. Specific structural and functional details disclosed herein are merely representative for purposes of describing example embodiments. Example embodiments, however, may be embodied in many alternate forms and should not be construed as limited to only the example embodiments set forth herein. On the contrary, example embodiments are to cover all modifications, equivalents, and alternatives thereof.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Before discussing example embodiments in more detail, it is noted that some example embodiments are described as processes or methods depicted as flowcharts. Although the flowcharts describe the operations as sequential processes, many of the operations may be performed in parallel, concurrently, or simultaneously. In addition, the order of operations may be re-arranged. The processes may be terminated when their operations are completed but may also have additional steps not included in the figures. It should also be noted that in some alternative implementations, the functions/acts/steps noted may occur out of the order noted in the figures. For example, two figures shown in succession may be executed substantially concurrently or may sometimes be executed in the reverse order, depending upon the functionality/acts involved.

Further, although the terms first, second, etc. may be used herein to describe various elements, components, regions, layers, and/or sections, it should be understood that these elements, components, regions, layers, and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the scope of example embodiments.

Spatial and functional relationships between elements (for example, between modules) are described using various terms, including “connected,” “engaged,” “interfaced,” and “coupled.” Unless explicitly described as being “direct,” when a relationship between the first and second elements is described in the description below, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular example embodiments only and is not intended to be limiting. Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless specifically stated otherwise, or as is apparent from the description, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

Embodiments of the present invention relate to a cloud-based customer relationship management (CRM) data storage system with query support. The system is configured to store large amounts of data and provides SQL equivalent interface to query and filter customer data. The system facilitates data backup for one or more customers by receiving source data that includes at least one of data schema, records or CRM data, and blob data, transforming the source data into a columnar storage format, generating index files, and storing versioning data along with the converted source data and index files. The system further enables query-based retrieval by identifying and scanning relevant index and data files based on query parameters and versioning data, thereby providing structured query support and efficient management of multiple versions of CRM data.

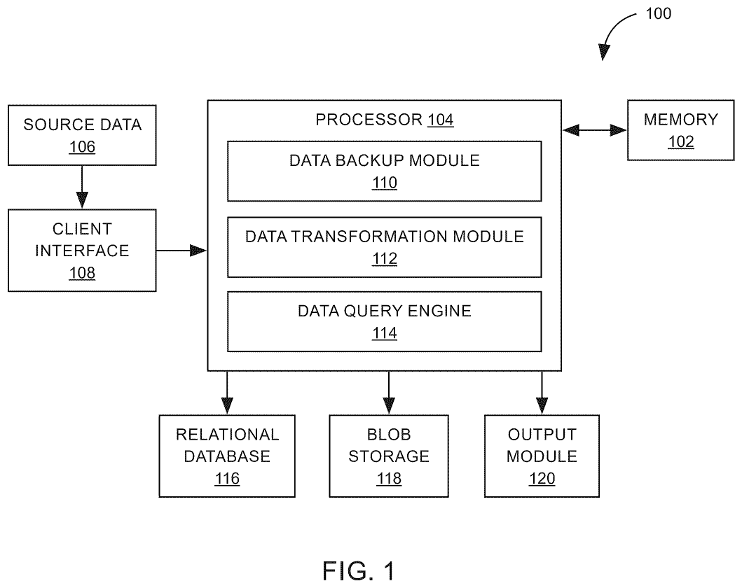

FIG. 1 is a block diagram illustrating components of a cloud-based customer relationship management (CRM) data storage system 100 with query support to implement some embodiments of the invention. The system 100 includes a memory 102, a processor 104, and a client interface 108. The memory 102 is configured to store one or more processor-executable routines. The processor 104 is communicatively coupled to the memory 102 and is configured to execute the one or more processor-executable routines to facilitate data backup, and data retrieval operations for customer data.

In the illustrated embodiment, the client interface 108 is configured to receive source data 106 corresponding to one or more customers of the system 100. Here, the source data 106 includes at least one of data schema, records/CRM data, and blob data. The client interface 108 is configured to receive the source data 106 from a customer database.

In an example embodiment, the processor 104 is configured to receive source data 106 corresponding to a plurality of data snapshots for each customer. The processor 104 is further configured to initiate retrieval of source data 106 for each version and/or data snapshot once a previous version and/or data snapshot is completed.

The processor 104 includes a data backup module 110, a data transformation module 112, and a data query engine 114. In an example embodiment, the data backup module 110 is configured to initiate a full data backup or an incremental data backup operation for the one or more customers of the cloud-based data storage system 100.

The data transformation module 112 is configured to transform the received source data 106 into a columnar storage format using the data schema and blob data to generate converted source data. In some embodiments, the columnar storage format may include a parquet format.

Further, the data transformation module 112 is configured to generate index files for the converted source data. Each of the index files having one or more of a primary key column, one or more foreign key columns, data file handles, or combinations thereof. The processor 104 is further configured to identify parent-child relationships of the data using the index files for data retrieval. In certain examples, the processor 104 is further configured to merge a plurality of index files for each version of data and corresponding data combination.

In this embodiment, the processor 104 further includes a relational database 116 configured to store versioning information for the source data 106 and a blob storage 118 configured to store the converted source data, along with corresponding index files for each customer. Each data file for the customers would be stored at <customer-id>/<backupset-id>/<version-id>/<object-id>/file to ensure that data for each customer is stored separately.

The data query engine 114 is configured to receive a data query from the one or more customers of the system 100. The data query may include one or more query parameters, such as snapshot information, data object identifiers, query commands, or combinations thereof. Based on the query parameters and the versioning data, the data query engine 114 is configured to identify one or more index files and/or data files to be scanned from the converted source data. The identified files are then scanned to generate data query results, which are presented to a user of the system 100 via an output module 120.

In certain embodiments, the processor 104 is configured to determine if search is required to be performed on one or more columns of the converted source data 106. In response, the processor 104 identifies one or more index files corresponding to the relevant columns identified for scanning. The processor 104 is further configured to identify the data files to be scanned for other respective columns of the converted source data.

The processor 104 is further configured to initiate the search using a batch processing tool, thereby enabling concurrent retrieval of data from the identified index and data files. In cases where multiple versions of a data record are present, the processor 104 is configured to merge the retrieved data query results and select a latest version of data record from the multiple versions. The output module 120 is configured to present the consolidated data query results to the user.

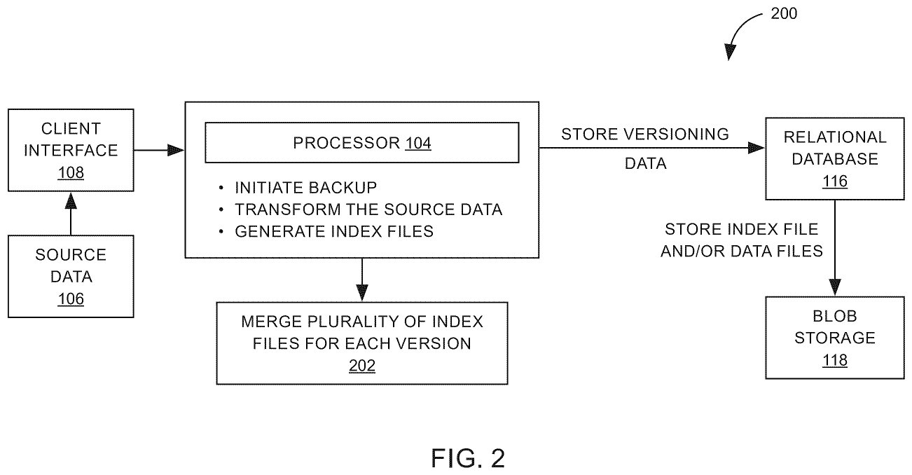

FIG. 2 illustrates an example backup workflow 200 of the cloud-based CRM data copy system 100 of FIG. 1. In this exemplary embodiment, the cloud-based CRM data storage system 100 facilitates version-controlled data backup operations. As described with reference to FIG. 1, the system 100 includes the processor 104, the client interface 108, the relational database 116, and the blob storage 118.

In an example embodiment, the system 100 is configured to facilitate a backup of CRM data. The client interface 108 is configured to receive the source data 106 corresponding to one or more customers. The received CRM source data may include data schema, records/CRM data, and associated blob data/metadata. The client interface 108 is configured to transmit the source data 106 to the processor 104 for further processing and backup.

The processor 104 is configured to receive source data 106 corresponding to the plurality of data snapshots for each customer and initiate retrieval of data for each version and/or data snapshot once a previous version and/or data snapshot is completed. The data backup module 110 is configured to perform a full data backup or the incremental backup for the one or more customers of the system.

The data transformation module 112 is configured to transform structured source data into a columnar storage format, such as Parquet, optimized for analytical processing During transformation, the data transformation module 112 is configured to generate a plurality of data files and index files corresponding to each CRM data object.

The processor 104 is configured to store versioning metadata corresponding to a plurality of data snapshots in the relational database 116. Concurrently, the generated data and index files are stored in the blob storage 118. The versioning metadata may include a version identifier, timestamp, customer identifier, parent version identifier, and index references linking each version entry to its corresponding data and index files stored in the blob storage 118.

Upon confirmation of successful upload of data snapshots by a customer, the snapshot version is marked as finalized. In some embodiments, the processor 104 is configured to merge multiple index files 202 corresponding to a specific data object and version combination to generate a consolidated index structure. Each version may represent a complete or an incremental dataset relative to previous versions, enabling efficient record reconstruction and version-aware query execution.

An example snapshot hierarchy generated using the system is illustrated below:

```
/snapshot_1/object_name/
  /metadata/schema
  snapshot_version/ object_name/ index.parq
  snapshot_version/ object_name/data1.parq
  snapshot_version/ object_name/data2.parq
  snapshot_version/ object_name/ blob_data/1
  snapshot_version/ object_name/ blob_data/2
/snapshot_2/object_name/
  snapshot_version/ object_name/ index.parq
  snapshot_version/ object_name/data1.parq
  snapshot_version/ object_name/data2.parq
```

As can be seen above, the hierarchy includes the relative path from a snapshot level and may be used to perform version-aware data queries and data restoration operations.

Table 1 illustrates an example of index file records generated within the cloud-based CRM data copy system 100 of FIG. 1.

TABLE 1

| Id | foreigncol1 | foreigncol2 | data_handle | deletedver | timestamp (ts) |
|---|---|---|---|---|---|
| Record 1 | 1 | 1 | data1.parq | 0 | 123 |
| Record 2 | 2 | 2 | data1.parq | 0 | 123 |
| Record 3 | 3 | 3 | data2.parq | 0 | 124 |
| Record 4 | — | — | — | 1 | 125 |

As illustrated in Table 1, each entry in the index file references a record's location within the corresponding data file and includes version control metadata such as deletion flags and timestamps. This enables efficient identification and reconstruction of records across multiple snapshots.

Table 2 illustrates an example of data file records generated within the cloud-based CRM data copy system 100 of FIG. 1.

TABLE 2

| Id | col1 | col2 | col3 | foreigncol1 | foreigncol2 |
|---|---|---|---|---|---|
| Record1 | A | B | C | 1 | 1 |
| Record2 | D | E | F | 2 | 2 |
| Record3 | G | H | I | 3 | 3 |

Table 2 represents a data file in columnar format, where each record is stored in serialized form that is optimised for analytical query performance and high-throughput retrieval. The system is configured to facilitate SQL-equivalent query execution over the backed-up data.

In an example, a backup flow is implemented using the system 100. For illustration, an organisation having a CRM Account is considered. The account may include multiple objects having records such as generally represented by identification numbers rid1 to rid10. In operation, the CRM data storage system may transmit records in batches such as of five data records along with their schema information during the backup process. In this example, a user client initiates a backup of Snapshot 1 as a full backup comprising data records organised in a Batch 1 (rid1-rid5) and a Batch 2 (rid6-rid10).

The processor 104 is configured to convert such source data into Parquet format, generate index files, and stores the schema, index, and data files in the blob storage 118. Once the upload is complete and the client marks the object/backup as completed, the processor 104 merges the index files for the Account object.

Once the backup of Snapshot 1 is completed, modifications to the data records are recorded. For example, records such as rid1 and rid2 are updated, record rid3 is deleted, and a new record rid11 is added.

During a subsequent backup, such as an incremental backup, the client interface 108 uploads the modified records rid1 and rid2, adds the new record rid11, and marks rid3 as deleted. The processor 104 processes and stores these updates in association with the updated version of the dataset.

Each index entry corresponding to the stored records includes version identifiers and deletion flags. These metadata parameters facilitate dataset reconstruction and version-aware query execution, enabling accurate retrieval of records corresponding to any historical snapshot version.

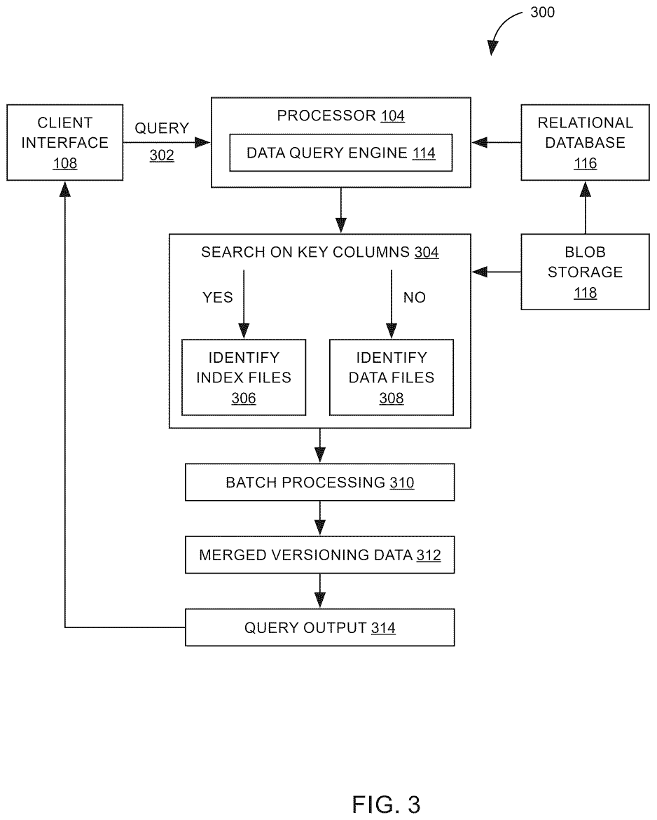

FIG. 3 illustrates an example query execution workflow 300 of the cloud-based CRM data copy system 100 of FIG. 1. As discussed, the system 100 is configured to implement query-based retrieval operations on versioned CRM data records. The client interface 108 is configured to receive a query 302 and to transmit query parameters such as snapshot identifiers, data object details, query commands, or combinations thereof, to initiate execution of the query 302.

In response, the processor 104 is configured to retrieve metadata and versioning information from the relational database 116 corresponding to the specified snapshot. This metadata includes details of incremental changes recorded since the previous backup of the data snapshot. Based on a query type, the data query engine 114 identifies one or more index files and/or data files to be scanned from the blob storage 118. In addition, the data query engine 114 is configured to determine if search is required to be performed on one more columns of the data such as represented by reference numeral 304.

The processor 104 is configured to identify relevant index files 306 for scanning if it is determined that the search is to be performed. For queries involving non-key or attribute columns, the processor 104 identifies the associated data files 308. The processor 104 is configured to initiate the search using batch processing tools 310 and concurrently retrieve data based on the identified index files 306 and data files 308.

In cases where multiple versions of the record exist, the processor 104 merges the versions 312 according to predefined rules. For example, if it is determined that the version is latest based on a recent timestamp and it is marked as deleted, then the record is excluded from the results; otherwise, the most recent version is selected. Upon completion of processing, the processor 104 generates query output 314, which is transmitted to the client interface 108 through the output module 120. This query functionality of the system 100 is further illustrated with reference to Table 3.

Table 3 illustrates an example of data query support using the cloud-based CRM data copy system 100 of FIG. 1.

TABLE 3

| Record | Query | Versions | Found in | |
|---|---|---|---|---|
| ID | Version | Identified | Version | Output |
| rid1 | 2 | 2, 1 | 2 | Returned |
| rid2 | 1 | 1 | 1 | Returned |
| rid3 | 1 | 1 | 1 | Returned |
| rid4 | 2 | 2, 1 | 2 | Deleted |
| rid5 | 2 | 2, 1 | 1 | Returned |

As illustrated in Table 3, for a data query of record rid1 from version 2, rid1 is detected in both versions 2 and 1. Therefore, both of these would be used to search and compute their paths for search. These paths and SQL like query such as “select * from <data file> where id=rid1” is used and searched in backup data. In this example, a plurality of snapshots is searched in parallel and here, as version 2 is the latest version, the data from version 2 is returned in response to the query.

Similarly, for a data query of Record rid2 from version 1, version 1 is identified as backup and the path for search is computed. Here again, multiple snapshots are searched in parallel and from latest to oldest data. In this case, rid2 is detected in version 1 as that is the only snapshot and so it is returned.

Similarly, for a data query of record rid3 from version 1, rid 3 is detected in snapshot 1 and returned. However, for a data query for record rid3 from version 2, the record is detected in snapshot 2 but marked as deleted, and the system identifies it accordingly. Record rid5 queried from version 2 is not detected in snapshot 2 but is detected in snapshot 1; therefore, the data from snapshot 1 is returned as a valid result.

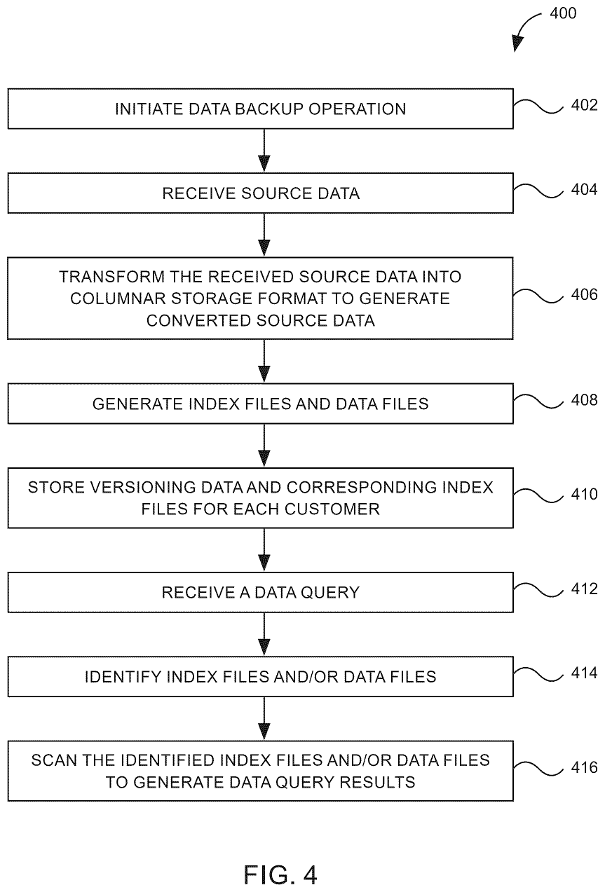

FIG. 4 is a flow chart illustrating a method 400 for providing query support in the cloud-based (CRM) data storage system 100 of FIG. 1. At block 402, the data backup operation for one or more customers of the cloud-based data storage system is initiated. The data backup operation may include a full data backup or an incremental backup operation for the one or more customers.

At block 404, the source data corresponding to the one or more customers is received. The source data may include at least one of data schema, records/CRM data and blob data.

At block 406, the received source data is transformed into a columnar storage format to generate converted source data. At block 408, index files for the converted source data are generated. At block 410, the versioning data and corresponding index files for each of the one or more customers is stored.

At block 412, a data query from one or more customers is received. The data query may include one or more query parameters, such as, but not limited to snapshot information, data object details, query commands, or combinations thereof. At block 414, index files and/or data files are identified to be scanned from the converted source data based on the one or more query parameters and the versioning data.

At block 416, the identified index files and/or data files are scanned to generate data query results. In some embodiments, a batch processing tool is used for the scan thereby enabling concurrent retrieval of data from the identified files. Moreover, the resulting query outputs may be merged to reconcile multiple record versions and the latest valid version of each record may be selected based on version identifiers or timestamps. The data query results are presented to the user of the system.

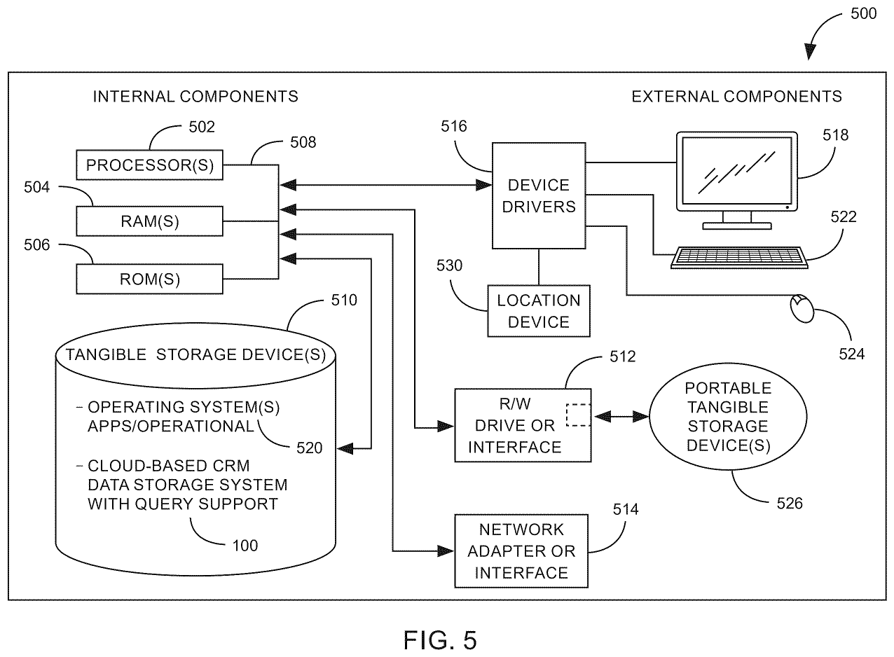

The modules of the cloud-based customer relationship management (CRM) data storage system 100 with query support, described herein, are implemented in computing devices to facilitate user assistance and task execution. One example of a computing device 500 is described below in FIG. 5. The computing device 500 includes one or more processor(s) 502, one or more computer-readable RAMs 504, and one or more computer-readable ROMs 506 on one or more buses 308. Further, the computing device 500 includes a tangible storage device 510 that may be used to execute operating systems 520 and the cloud-based CRM data storage system 100 with query support. The various modules of the cloud-based CRM data storage system 100 with query support may be stored in the tangible storage device 510. Both, the operating systems 520 and the cloud-based CRM data storage system 100 with query support are executed by one or more processor(s) 502 via one or more respective RAMs 504 (which typically include cache memory). The execution of the operating systems 520 and/or the cloud-based CRM data storage system 100 with query support by the one or more processor(s) 502, configures the one or more processor(s) 502 as a special purpose processor configured to carry out the functionalities of the operation systems 520 and/or the cloud-based CRM data storage system 100 with query support as described above.

Examples of tangible storage devices 510 include semiconductor storage devices such as ROM, EPROM, flash memory, or any other computer-readable tangible storage device that may store a computer program and digital information.

The computing device 500 also includes an R/W drive or interface 514 to read from and write to one or more portable computer-readable tangible storage devices 528 such as a CD-ROM, DVD, memory stick, or semiconductor storage device. Further, network adapters or interfaces 512 such as TCP/IP adapter cards, wireless Wi-Fi interface cards, or 3G or 4G wireless interface cards, or other wired or wireless communication links are also included in computing devices.

In one example embodiment, the cloud-based CRM data storage system 100 with query support may be stored in the tangible storage device 510 and may be downloaded from an external computer via a network (for example, the Internet, a local area network, or other, wide area network) and network adapter or interface 512.

Computing device 500 further includes device drivers 516 to interface with input and output devices. The input and output devices may include a computer display monitor 518, a keyboard 522, a keypad, a touch screen, a computer mouse 524, and/or some other suitable input device.

In this description, including the definitions mentioned earlier, the term ‘module’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware. The term code, as used above, may include software, firmware, and/or microcode, and may refer to programs, routines, functions, classes, data structures, and/or objects.

Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above. Shared memory hardware encompasses a single memory device that stores some or all code from multiple modules. Group memory hardware encompasses a memory device that, in combination with other memory devices, stores some or all code from one or more modules.

In some embodiments, the module may include one or more interface circuits. In some examples, the interface circuits may include wired or wireless interfaces that are connected to a local area network (LAN), the Internet, a wide area network (WAN), or combinations thereof. The functionality of any given module of the present description may be distributed among multiple modules that are connected via interface circuits. For example, multiple modules may allow load balancing. In a further example, a server (also known as remote, or cloud) module may accomplish some functionality on behalf of a client module.

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

While only certain features of several embodiments have been illustrated, and described herein, many modifications and changes will occur to those skilled in the art. It is, therefore, to be understood that the appended claims are intended to cover all such modifications and changes as fall within the true spirit of inventive concepts.

The aforementioned description is merely illustrative in nature and is in no way intended to limit the disclosure, its application, or its uses. The broad teachings of the disclosure may be implemented in a variety of forms. Therefore, while this disclosure includes particular examples, the true scope of the disclosure should not be so limited since other modifications will become apparent upon a study of the drawings, and the specification. It should be understood that one or more steps within a method may be executed in different order (or concurrently) without altering the principles of the present disclosure. Further, although each of the example embodiments is described above as having certain features, any one or more of those features described with respect to any example embodiment of the disclosure may be implemented in and/or combined with features of any of the other embodiments, even if that combination is not explicitly described. In other words, the described example embodiments are not mutually exclusive, and permutations of one or more example embodiments with one another remain within the scope of this disclosure.

The example embodiment or each example embodiment should not be understood as a limiting/restrictive of inventive concepts. Rather, numerous variations and modifications are possible in the context of the present disclosure, in particular those variants and combinations which may be inferred by the person skilled in the art with regard to achieving the object for example by combination or modification of individual features or elements or method steps that are described in connection with the general or specific part of the description and/or the drawings, and, by way of combinable features, lead to a new subject matter or to new method steps or sequences of method steps, including insofar as they concern production, testing and operating methods. Further, elements and/or features of different example embodiments may be combined with each other and/or substituted for each other within the scope of this disclosure.

Still further, any one of the above-described and other example features of example embodiments may be embodied in the form of an apparatus, method, system, computer program, tangible computer readable medium and tangible computer program product. For example, of the aforementioned methods may be embodied in the form of a system or device, including, but not limited to, any of the structure for performing the methodology illustrated in the drawings.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Further, at least one example embodiment relates to a non-transitory computer-readable storage medium comprising electronically readable control information (e.g., computer-readable instructions) stored thereon, configured such that when the storage medium is used in a controller of a magnetic resonance device, at least one example embodiment of the method is carried out.

Even further, any of the aforementioned methods may be embodied in the form of a program. The program may be stored on a non-transitory computer readable medium, such that when run on a computer device (e.g., a processor), cause the computer device to perform any one of the aforementioned methods. Thus, the non-transitory, tangible computer readable medium is adapted to store information and is adapted to interact with a data processing facility or computer device to execute the program of any of the above-mentioned embodiments and/or to perform the method of any of the above-mentioned embodiments.

The computer readable medium or storage medium may be a built-in medium installed inside a computer device's main body or a removable medium arranged so that it may be separated from the computer device's main body. The term computer-readable medium, as used herein, does not encompass transitory electrical or electromagnetic signals propagating through a medium (such as on a carrier wave), the term computer-readable medium is therefore considered tangible and non-transitory. Non-limiting examples of the non-transitory computer-readable medium include but are not limited to, rewriteable non-volatile memory devices (including, for example, flash memory devices, erasable programmable read-only memory devices, or mask read-only memory devices), volatile memory devices (including, for example, static random access memory devices or a dynamic random access memory devices), magnetic storage media (including, for example, an analog or digital magnetic tape or a hard disk drive), and optical storage media (including, for example, a CD, a DVD, or a Blu-ray Disc). Examples of the media with a built-in rewriteable non-volatile memory, include but are not limited to memory cards, and media with a built-in ROM, including but not limited to ROM cassettes, etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave), the term computer-readable medium is therefore considered tangible and non-transitory. Non-limiting examples of the non-transitory computer-readable medium include but are not limited to, rewriteable non-volatile memory devices (including, for example flash memory devices, erasable programmable read-only memory devices, or a mask read-only memory devices), volatile memory devices (including, for example static random access memory devices or a dynamic random access memory devices), magnetic storage media (including, for example an analog or digital magnetic tape or a hard disk drive), and optical storage media (including, for example a CD, a DVD, or a Blu-ray Disc). Examples of the media with a built-in rewriteable non-volatile memory, include but are not limited to memory cards, and media with a built-in ROM, including but not limited to ROM cassettes, etc. Furthermore, various information regarding stored images, for example, property information, may be stored in any other form, or it may be provided in other ways.

The apparatuses and methods described in this application may be partially or fully implemented by a special purpose computer created by configuring a general-purpose computer to execute one or more particular functions embodied in computer programs. The functional blocks and flowchart elements described above serve as software specifications, which may be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

What is claimed is:

1. A cloud-based customer relationship management (CRM) data storage system with query support, wherein the system comprises:
a memory storing one or more processor-executable routines; and
a processor communicatively coupled to the memory, the processor configured to execute the one or more processor-executable routines to:
initiate a data backup operation for one or more customers of the cloud-based data storage system,
receive source data corresponding to the one or more customers, wherein the source data comprises at least one of data schema, records/CRM data, and blob data;
transform the received source data into a columnar storage format to generate converted source data;
generate index files for the converted source data;
store versioning data for the source data using a database;
store converted source data and corresponding index files for each customer using a blob storage;
receive a data query from one or more customers, wherein the data query comprises one or more query parameters;
identify index files and/or data files to be scanned from the converted source data based on the one or more query parameters and the versioning data;
scan the identified index files and/or data files to generate data query results.

2. The cloud-based (CRM) data storage system of claim 1, wherein the processor is configured to perform a full data backup or an incremental data backup operation for the one or more customers of the cloud-based data storage system.

3. The cloud-based (CRM) data storage system of claim 1, wherein the processor is configured to:
receive source data corresponding to a plurality of data snapshots for each customer;
initiate retrieval of data for each version and/or data snapshot once a previous version and/or data snapshot is completed.

4. The cloud-based (CRM) data storage system of claim 1, wherein the processor is configured to transform the received source data into the columnar storage format using the data schema and blob data, and wherein the columnar storage format comprises a parquet format.

5. The cloud-based (CRM) data storage system of claim 1, wherein each of the index files comprises a primary key column, one or more foreign key columns, data file handles, or combinations thereof and wherein the processor is further configured to identify parent-child relationships of the data using the index files for data retrieval.

6. The cloud-based (CRM) data storage system of claim 5, wherein the processor is configured to merge a plurality of index files for each version and corresponding data combination.

7. The cloud-based (CRM) data storage system of claim 1, wherein the one or more query parameters comprise snapshot information, data object details, query commands, or combinations thereof.

8. The cloud-based (CRM) data storage system of claim 1, wherein the processor is further configured to:
determine if search is required to be performed on one or more columns of the converted source data;
identify one or more index files to be scanned if it is determined that the search is to be performed on the one or more columns; and
identify data files to be scanned for other respective columns of the converted source data.

9. The cloud-based (CRM) data storage system of claim 8, wherein the processor is further configured to initiate the search using a batch processing tool and concurrently retrieve data based on the identified index files and data files.

10. The cloud-based (CRM) data storage system of claim 9, wherein the processor is further configured to merge data query results to handle multiple versions of results, wherein the processor is configured to select a latest version of data record from the multiple versions.

11. A cloud-based (CRM) data storage system with query support, wherein the system comprises:
a memory storing one or more processor-executable routines; and
a processor communicatively coupled to the memory, the processor configured to execute the one or more processor-executable routines to facilitate data backup and data retrieval operations for customer data, wherein the processor comprises:
a client interface configured to receive source data corresponding to one or more customers, wherein the source data comprises at least one of data schema, records/CRM data and blob data;
a data transformation module configured to transform the received source data into a columnar storage format to generate converted source data and generate index files for the converted source data;
a data query engine configured to receive a data query from the one or more customers, wherein the data query comprises one or more query parameters and wherein the data query engine is configured to:
identify index files and/or data files to be scanned from the converted source data based on the one or more query parameters and versioning data; and
scan the identified index files and/or data files to generate data query results.

12. The cloud-based (CRM) data storage system of claim 11, wherein the system further comprises:
a relational database configured to store versioning data for the source data;
a blob storage configured to store converted source data and corresponding index files for each customer; and
an output module configured to present the data query results to a user of the system.

13. The cloud-based (CRM) data storage system of claim 11, wherein the processor further comprises a data backup module configured to perform a full data backup or an incremental data backup operation for the one or more customers of the cloud-based data storage system.

14. The cloud-based (CRM) data storage system of claim 11, wherein the client interface is configured to receive the source data from a customer database.

15. The cloud-based (CRM) data storage system of claim 11, wherein the data transformation module is configured to transform the received source data into one of a parquet format.

16. The cloud-based (CRM) data storage system of claim 11, wherein the one or more query parameters comprise snapshot information, data object details, query commands, or combinations thereof.

17. A method of providing query support in a cloud-based (CRM) data storage system, the method comprising:
initiating a data backup operation for one or more customers of the cloud-based data storage system,
receiving source data corresponding to the one or more customers, wherein the source data comprises at least one of data schema, records/CRM data and blob data;
transforming the received source data into a columnar storage format to generate converted source data;
generating index files for the converted source data;
storing versioning data and corresponding index files for each customer;
receiving a data query from one or more customers, wherein the data query having one or more query parameters;
identifying index files and/or data files to be scanned from the converted source data based on the one or more query parameters and the versioning data;
scanning the identified index files and/or data files to generate data query results.

18. The method of claim 17, further comprising initiating the scan using a batch processing tool to concurrently retrieve data based on the identified index files and data files.

19. The method of claim 17, further comprising merging data query results to handle multiple versions of results, wherein the processor is configured to select a latest version of data record from the multiple versions.

20. The method of claim 17, comprising performing a full data backup or an incremental backup operation for the one or more customers.
